(19) United States
(12) Patent Application Publication
(10) Pub. No.: US 2011/0162455 A1
(43) Pub. Date: Jul. 7, 2011

(54) METHOD FOR NON-DESTRUCTIVE ULTRASONIC TESTING AS WELL AS DEVICE FOR THE IMPLEMENTATION OF THE METHOD

(75) Inventor: Peter Renzel, Duren (DE)

(73) Assignee: GE SENSING & INSPECTION TECHNOLOGIES GMBH, HURTH (DE)

(21) Appl. No.: 12/997,799

(22) PCT Filed: Jun. 10, 2009
(86) PCT No.: PCT/EP09/57145

§ 371 Date: Mar. 15, 2011

(30) Foreign Application Priority Data
Jun. 13, 2008 (DE) 10 2008 002 426.0
Sep. 23, 2008 (DE) 10 2008 042 278.9

(51) Int. Cl. G01N 29/34

(52) U.S. Cl. 73/632

(57) ABSTRACT

The invention relates to a method for non-destructive ultra-sonic testing, in which ultrasonic pulses with a pulse repetition frequency are radiated by means of an ultrasonic transmitter into a workpiece to be tested and the ultrasonic pulses are reflected to bounding surfaces in the workpiece and the reflected ultra sound is recorded by means of an ultra-sonic receiver and the signals are displayed in time- or position-dependent resolution. The method is characterized in that the pulse repetition frequency is changed at least once during the method.

The invention relates to a pulse-echo method for ultrasonic materials testing. It is a matter thereby of an acoustic method for the discovery of material faults, in which ultra sound is utilized. Ultrasonic testing is among the non-destructive test methods. Thereby, component parts can also be tested in the built-in condition, for example, the bearing elements of an aircraft. Ultrasonic testing is an appropriate test method with sound-conductive materials (including most metals) for the discovery of internal and external faults, for example, with welding seams, forgings, casting, semi-finished products or pipes. In machine construction, the inspection of the quality of the component parts is an important requirement, in order to ensure, for example, the safety of passenger transportation equipment or piping, for example, for hazardous materials. Laid railroad tracks are routinely tested by test trains. Therefore, the increase in the reliability of this method is aimed for.

Like all methods of testing, ultrasonic inspection is also standardized and performed according to guidelines, for example, according to the DIN EN 10228-3 1998-07, Non-Destructive Testing of Forgings of Steel—Part 3: Ultrasonic Testing of Forgings of Ferritic and Martensitic Steel, which is included herewith by reference. Suitable testing sets and methods are known for the non-destructive testing of a test piece by ultrasound. Reference is quite commonly made to the textbook of J. and. H. Krautkrämer, Materials Testing with Ultrasound, sixth edition.

This method is commonly based on the reflection of sound to bounding surfaces. As the sound source, one uses mostly an ultrasonic transducer or probe, whose radiation lies in the frequency range of 10 kHz to 100 MHz. With pulse-echo methods, the ultrasonic transducer emits no continuous radiation, but rather very short acoustic pulses, whose duration is 1 μs and less. The pulse emanating from the transmitter passes through the test piece to be tested with the appropriate sound velocity and is reflected almost completely to the bounding surface metal-air. The sonic transducer can for the most part emit not only pulses, but rather also convert in-coming pulses into electrical measuring signals; thus, it also operates as a receiver. The time, which the acoustic pulse needs, in order to come from the transmitter through the workpiece and back again is measured with an oscilloscope or a computer unit, to which an analog-digital converter is connected upstream. With known sound velocity c in the material, the thickness of a sample can be tested in this manner. For the coupling between workpiece and ultrasonic transducer, a coupling means (for example, paste (solution), gel, water or oil) is applied to the surface of the workpiece to be tested. Mostly, the surface to be tested is taken out of service with the probe. This can be effected manually, in a mechanized manner or automatically (within the assembly lines). With the latter, the test piece is often immersed in an appropriate fluid (immersion technique), or defined wetted for the purpose of transfer of the acoustic signal.

Changes of the acoustic properties at bounding surfaces, i.e., at the external wall surfaces limiting the test piece, but also at the internal bounding surfaces, i.e., faults in the interior, such as a cavity (hollow space), an inclusion, a crack or another separation in the structure in the interior of the workpiece to be tested, reflect the acoustic pulse and send this back to the oscillator in the probe, which acts both as the transmitter and also as the receiver. The elapsed time between the sending and reception permits the calculation of the path. By means of the measured time difference, a signal image is produced and is shown on a monitor or oscilloscope. By means of this image, the position can be determined and, if necessary, the size of the fault (in the technical language referred to as discontinuity) can be assessed by comparison with a replacement reflector (flat-bottom hole (circular disc-shaped reflector), groove, cross-drilled hole). Generally, discontinuities can be detected with a size of approx. 0.6 mm, with special methods also up to 0.1 mm or less. With automatic test rigs, the information is stored, put into perspective for the test piece, and documented in different ways immediately or later.

The ultrasonic pulses produced by the probe are mostly irradiated repeatedly into the workpiece with a fixed pulse repetition frequency. Since the workpieces have wall surfaces or wall surface sections frequently oriented perpendicular to the propagation direction and parallel to each other, multiple reflections (multiple echoes) occur to these wall surfaces and thus pulses running back and forth in the workpiece, which in addition to possible reflections are received through the discontinuity by the probe. Due to the mostly high reflection coefficient, these multiply reflected pulses are clearly discernible. If the pulses follow with a clear time-lag, if the pulse repetition frequency is comparatively low, the multiple reflections can easily be assigned through the time separation in the signal image to the associated pulse. It appears differently, if the pulse repetition frequency is so high, i.e., the time-lag between the pulses is so small, that the multiple reflections, thus pulses, which were reflected more than once to a workpiece wall surface, are first detected after the transmission of the next or a subsequent pulse. Then the danger exists, that the multiple reflection of a preceding pulse occurring after a subsequent pulse is not detected as such, but rather is regarded falsely as a reflection of the immediately preceding pulse, i.e., a reflection going back to the latter, which could be produced through a discontinuity existing in the workpiece. This leads to a false alarm in the workpiece testing, so that this workpiece is reexamined or perhaps falsely discarded as a rejection. The production costs increase. The allocation problem has increased with a quartz stabilization of the pulse repetition frequency. It is to the credit of the inventor of this invention, to have recognized this problem and to have seen his task therein. Furthermore, he has provided a solution for this problem with the existing invention.

The invention has set itself the task of making a pulse-echo method for the workpiece testing more reliable as well as to specify a device for the ultrasonic testing, which permits a more reliable testing of a workpiece. This task is achieved by a method according to claim 1 as well as by a device according to claim 7. The dependent claims are related in each case to advantageous embodiments.

The invention relates to a method for non-destructive ultrasonic testing, whereby ultrasonic pulses with a pulse repetition frequency are re-echoed by means of an ultrasonic transmitter into a workpiece to be tested, consisting essentially of a sound-conductive material. The ultrasonic pulses are reflected according to the present invention to bounding surfaces in the workpiece. The concept bounding surface can be broadly interpreted in terms of the invention. For example, it is a matter of an external bounding surface, i.e., the workpiece limiting wall surfaces, or, however, an internal bounding surface, i.e., a fault in the interior of the workpiece, such as such as a cavity (hollow space), an inclusion, a crack or another separation in the structure. The reflected ultra sound, depending on the reflection behavior of the bounding surface, in most cases also a signal in pulse form, is recorded according to the present invention by means of an ultrasonic receiver. With the ultrasonic receiver and the ultrasonic transmitter it can be a matter of one and the same ultrasonic transducer; however, it does not have to be. The recorded signals are displayed in time- or position-dependent depiction, for example by means of an oscilloscope or a computer program product, which is performed on a computer with display device. The position-dependent depiction is connected, for example, with the time-dependent depiction via the propagation velocity.

According to the present invention, the method is characterized in that the pulse repetition frequency f is suddenly changed at least once during the implementation of the method, i.e., the pulse repetition frequency f is preferably increased or decreased at least once by a preset hop magnitude Δf. Thus, the method becomes more reliable, since the change of the pulse repetition frequency f permits a clear, also visual allocation of reflections to their associated pulses. Despite change of the pulse repetition frequency f, the multiple reflections (multiple echoes) occurring as a rule and particularly in workpieces provided with coplanar walls keep their mutual distance in the time-dependent depiction. Through change of the pulse repetition frequency f, however, the pulses, together with their depicted multiple reflections, are time-shifted; this shift is discernible and identifiable with the time-dependent or also position-dependent depiction. This identification is particularly advantageous, when a multiple reflection of a previously transmitted pulse falls temporally behind the transmission of a subsequent pulse and is thus falsely regarded as a reflection of a subsequent pulse to a discontinuity in the workpiece. With such a situation, the procedural method according to the present invention is especially helpful. Through the change of the pulse repetition frequency f, this multiple reflection of the preceding pulse changes its distance in the time-dependent or position-dependent depiction as regards the subsequent pulse or as regards its reflections. Should this not be the case, it must be a matter of a reflection of the subsequent pulse and, if necessary, depending on the chronology, a matter of a reflection, which is to be attributed to a discontinuity in the workpiece. Thus, the method according to the present invention contributes to increasing the reliability of such testing methods with ultrasonic pulses, to minimizing the rejections, and to reducing production costs.

Preferably, the pulse repetition frequency f lies in the range of 500 Hz to 1.5 kHz, more preferably in the range 900 Hz to 1.1 kHz, still more preferably in the range of 990 to 1 kHz. For example, it amounts to 994 Hz. It has been shown that with such a repetition-frequency f of pulses an especially rapid and reliable testing can be performed.

In a further advantageous embodiment, the hop Δf, with which the pulse repetition frequency f is changed, i.e., the hop width is in the range of 0.25 to 10 Hz, more preferably in the range of 0.5 Hz to 5 Hz. Still more preferably, the hop width amounts to 1 Hz. In extensive samplings, it has been shown that the shift effected by the thus selected frequency-hop Δf between the reflections of pulses ordered in different chronologies suffices, with the usually occurring half-widths of the pulses to keep its reflections clearly discernibly apart.

Preferably, the pulse repetition frequency f is changed repeatedly (for example, there and back) according to a defined time lapse. Thereby the defined time lapse lies in the range of 100 to 500 ms and amounts preferably to 400 ms.

The method proves to be especially advantageous, if the pulse repetition frequency f is quartz stabilized. Due to the thus comparatively stable production of the frequency f of the successive pulses, the chronology of the associated reflections can be comparatively precisely determined.

The method according to the present invention is automatically actuated in an embodiment, in which by means of a timer circuit after expiration of a time duration of 400 ms, the pulse repetition frequency f is reduced from 994 Hz by 1 Hz to 993 Hz, in order to be increased again after expiration of a time duration of 400 ms to 994 Hz. This is repeated periodically up to the interruption of the method according the present invention.

In another embodiment, for example, an ultrasonic transducer of the type CA 211a offered by the company GE Inspection Technologies GmbH, Robert Bosch Str. 3, 50354 Hürth, Germany, is used, in combination with an ultrasonic test apparatus of the type USLT 2000 of the same offerer. The method is implemented, for example, with a steel unit under test with a thickness of greater than 200 mm, in which the ultra sound is injected in a perpendicular intromission.

Further advantageous embodiments result from the variegated methodological equipment of the subsequently described device according to the present invention, which can also be drawn on in its entirety for the further development of the method according to the present invention.

A device according to the present invention is provided for the non-destructive ultrasonic testing of an animate or inanimate unit under test. It has an ultrasonic transmitter, which is equipped, to produce ultrasonic pulses and to intromit sound into a unit under test. An ultrasonic receiver, which can also be identical to the ultrasonic transmitter, is provided, to receive echo-signals of the ultrasonic pulses intromitted into the unit under test. Furthermore, a control unit is provided, which is equipped, to excite the ultrasonic transmitter for the transmission of a sequence of ultrasonic pulses with a defined pulse repetition frequency f. Thereby, a clock-pulse generator stabilized preferably on a reference oscillator is provided for the stabilization of the pulse repetition frequency f, for example, a quartz stabilized oscillating circuit.

According to the present invention, a frequency variation unit is now furthermore provided, preferably in a control unit, which is equipped, to change the pulse repetition frequency f by a preset amount Δf. In the process, the variation amount Δf can be adjusted or changed, preferably manually by an operator. In an especially preferred embodiment, a (mechanical) adjustment element like a mechanical rotary adjustment stage is provided in the control unit, by means of which the frequency change Δf can be changed continuously or quasi-continuously (for example, with digital activation of the ultrasonic transmitter).

Alternatively, the variation amount Δf can be so adjusted—preferably automatically—, that a shift of phantom echoes of 3-5% of the imaging area adjusted to a display of an evaluation unit is discernible compared to the useful echoes (i.e., the echoes connected with real structures of the unit under test). A suitable algorithm is discussed in the framework of the execution example.

In another advantageous further development, a software-implemented detection unit, for example, is provided, for example, in the control unit, which is equipped, to detect such echo signals, whose time lag T from the preceding excitation pulse is apparently changed during a change of the pulse repetition frequency f by the amount Δf. In particular, the detection unit can be equipped, to acquire the apparent change ΔT of the time lag T of the detected echo signals and to compare it with the variation Δf of the pulse repetition. Particular advantages result, if the detection unit is equipped, to mark and/or to inhibit for a further processing the detected echo signals, particularly those echo signals, whose time lag T varies with the frequency Δf. In this way, signals identified as “phantom echoes,” for example, can be excluded from a display on a display unit assigned to the device or be indicated in a special manner, for example, by being color-marked.

In an alternative or supplemental embodiment, the detection unit is equipped to vary the pulse repetition frequency f, until no echo signals are detected any more, whose time lag T from the preceding excitation pulse is apparently changed during a change of the pulse repetition frequency f. In the process, the variation of the pulse repetition frequency f can take place continuously or in a large number of discrete stages.

Preferably, a display unit is assigned to the device according to the present invention, integrated particularly into the latter, on which the echo signals recorded by the ultrasonic receiver are displayed in time- or position-dependent resolution.

Especially preferred is the device according to the present invention quite commonly equipped to carry out the method according to the present invention in a (partially) automated manner in its different embodiments.

In the following, the invention is elucidated in greater detail by means of the drawing, without this being limited to that which is shown. In this are shown:

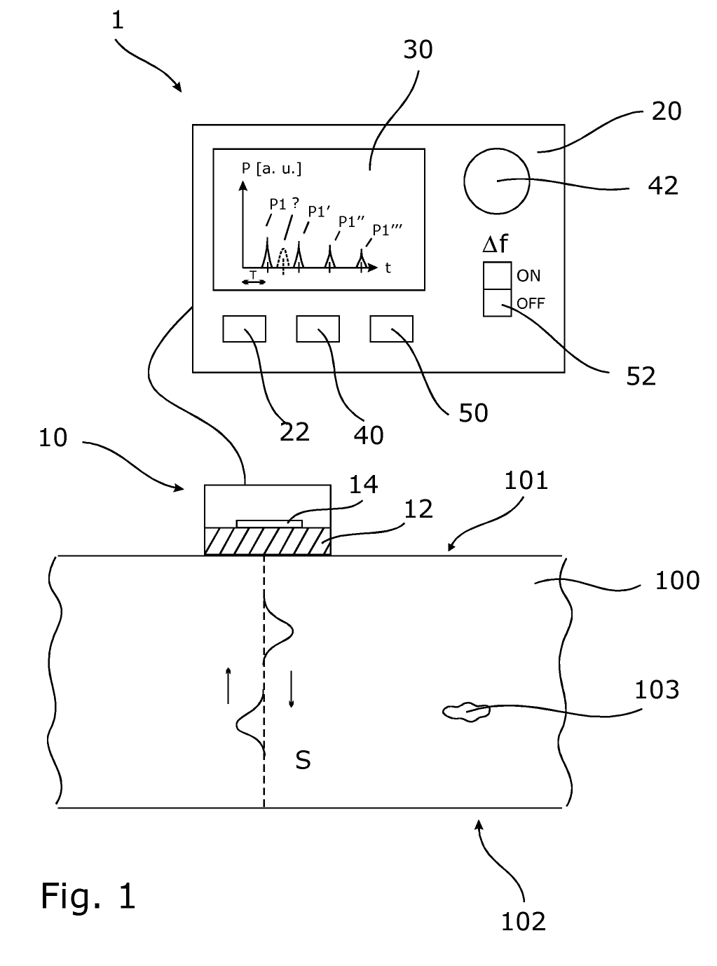

FIG. 1 a schematic depiction of a device according to the present invention,

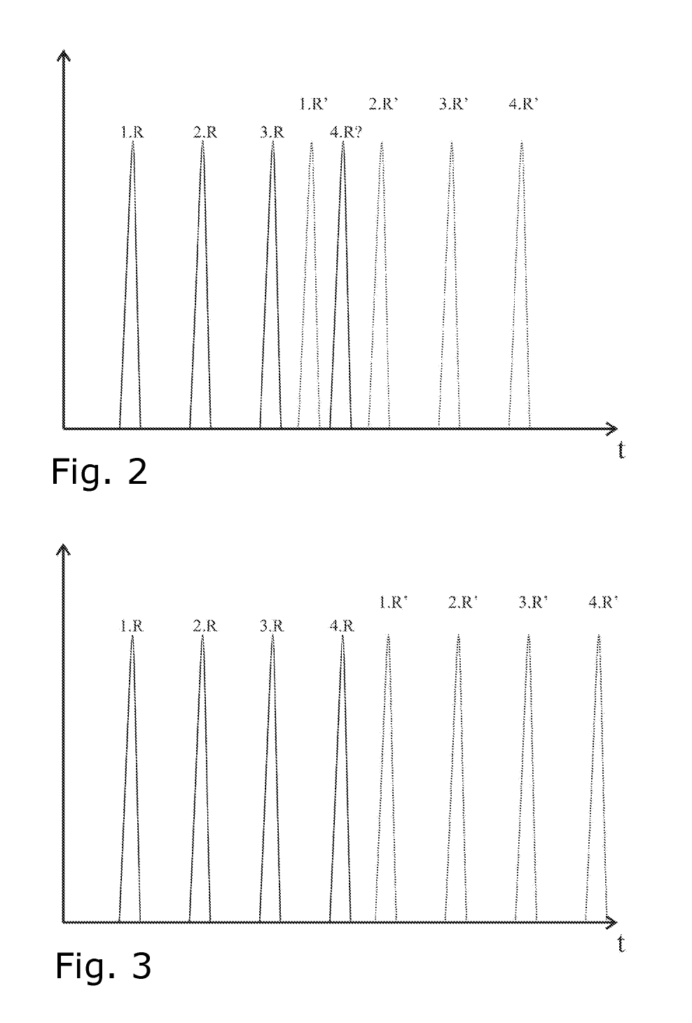

FIG. 2-4: a schematic depiction of typical signal runs in the framework of the method according to the present invention (“A-scan”), and

FIG. 5. a schematic depiction of the echo succession sequence depicted on a display of an evaluation unit for the elucidation of an automated adjustment of the pulse variation frequency Δf.

FIG. 1 shows, for example, an embodiment of a device 1 according to the present invention in a schematic depiction. The device 1 according to the present invention comprises a control unit 20, which is connected electrically with an ultrasonic transmitter 10, which functions at the same time as an ultrasonic receiver. The ultrasonic transmitter 10 comprises an ultrasonic transducer, which is arranged on a start-up body 12, for example, made of Plexiglas®, in which both are arranged in a common housing. The control unit 20 is equipped, to excite the ultrasonic transmitter 10 for the transmission of a sequence of ultrasonic pulses with a defined pulse repetition frequency f, which typically lies in the range of approximately 1 kHz. In order to stabilize the pulse repetition frequency f, a quartz stabilized clock-pulse generator 22 is provided in the control unit 20, in which a preferably temperature-stabilized quartz crystal is used as reference oscillator.

The ultrasonic transmitter 10 is fitted with 9 a start-up body 12 on the entrance surface 101 of a unit under test and intromits sound into these ultrasonic pulses with an acoustic frequency, which lies in the range between 10 kHz and 10 MHz, preferably in the range of 1 to 5 MHz, with the aforementioned pulse repetition frequency f in the unit under test 100. These propagate in the unit under test along the sound path S, are reflected to the back wall 102 of the unit under test 100, and arrive on the sound path S back at the ultrasonic transmitter 10, which is actuated by the control unit 20 alternately as ultrasonic transmitter and as ultrasonic receiver. The echo signals recorded by the ultrasonic receiver 10 from the unit under test 100, in which it can, for example, be a matter of the echo of the entrance surface, of the back-wall echoes as well as of the echo signals, which can derive from defects 103 found in the volume of the unit under test, are intensified in the control unit 20, digitalized and subsequently displayed on a display unit 30 provided in the control unit 20. FIG. 1 shows a time-resolved depiction of the receiving echo signals (A-Scan). To be sure, an in-depth resolved depiction can also be produced. In the execution example according to FIG. 1, a majority of peaks is depicted on the display unit 30, whereby with the peaks designated by P1 it is a matter of the entrance echo of a pulse intromitted into the unit under test 100. With the further depicted peaks P1′, P1″ as well as P1′″ it is a matter of the first, the second as well as the third back-wall echo.

Now, if the geometrical dimensions of the unit under test 100 are such that the sonic run-time of a pulse along the sound path S from the ultrasonic transmitter 10 up to the back wall 102 and back to the ultrasonic receiver 10 lies in the order of magnitude of the time lag of two successive emitter pulses P1, particularly if this run-time is even greater than the time lag of two successive emitter pulses, then it is questionable, whether with the further peak identified in FIG. 1 by “P?” it is a matter of an echo signal, which derives from a fault 103 in the volume of the unit under test 100, or whether it is a matter of a higher-order back-wall echo signal of a previous excitation pulse P1. In order to be able to make this differentiation, however, at least to give the inspector assistance in the classification of the peaks identified by “P?”, the device 1 depicted in FIG. 1 is equipped for the implementation of the method according to the method, which is specified below.

In general, a frequency variation unit 40 is designed in the control unit 20 of the device according to the present invention, which can be implemented in a hardware- or software implemented manner. This frequency variation unit 40 is equipped, to change the pulse repetition frequency f of the excitation pulses by a preset amount Δf. Preferably, it is equipped to change the pulse repetition frequency f periodically and the amount Δf, whereby the amount of this frequency change in turn lies preferably in the range between 0.1 and 100 Hz, especially preferably between 1 and 10 Hz. In the execution example shown, the control unit 20 comprises a mechanical adjustment element 42, which is designed as a control dial. This adjustment element 42 permits an operator to manually change the frequency change Δf, by means of which the frequency variation unit 40 periodically changes the pulse repetition frequency f of the emitter pulses.

Furthermore, in the control unit 20, a detection unit 50 is designed, which in turn can be implemented in a hardware- or software-implemented manner. This detection unit 50 is equipped to detect such echo signals, whose time lag T from the previous excitation pulse P1 apparently changes with a change of the pulse repetition frequency f. In particular, the detection unit 50 is equipped to acquire the apparent change ΔT of the time lag T of the detected echo signals and to compare this apparent change ΔT with the variation Δf of the pulse repetition frequency f. If the apparent change ΔT of the time lag T essentially corresponds, i.e., within the preset error limits, to the variation Δf of the pulse repetition frequency f, then the frequency variation unit is equipped, to discern such echo signals as “phantom-echoes” and to mark them as suitable for a further processing. In particular, the detection unit 50 can be equipped to exclude the echo signals identified in the previously described manner from a depiction on the display unit 30 with the activation of a corresponding “masking function,” for example, by means of actuation of an mechanical switch 20 provided in the control unit 20.

FIG. 2 shows schematically the signal run measured by the ultrasonic receiver 10 in a thick workpiece with coplanar surfaces. The reflections obtained from a first ultrasonic pulse P (1.R, first back-wall echo) and multiple reflections (2. R, 3. R, 4. R . . . ) on the wall surfaces limiting the workpiece are depicted in each case with a continuous line. The reflections (1.R′) obtained from a second ultrasonic pulse P′ and multiple reflections (2.R′, 3. R′, 4. R′ . . . ) on the wall surfaces limiting the workpiece are depicted in each case with a perforated line. For reasons of simplification, the entrance echo is inhibited and the signal strength of the multiple reflections is immediately selected. In reality, the signals are weakened with the number of the reflections, for example, due to the reflection losses. As FIG. 2 shows, in dense succession of pulses, the reflections of the first pulse P′ can occur after the first back-wall echo of the second pulse P. In the case shown, the 4^{th} reflection of the first pulse P (4.R) lies chronologically after the first reflection of the second pulse P (1.R′). Thus, the question is posed, whether with this peak it is actually a matter of a reflection, which can be attributed to the second pulse P′ and thus possibly a discontinuity in the workpiece, or it is in fact a multiple reflection here 4.R of the first pulse P.

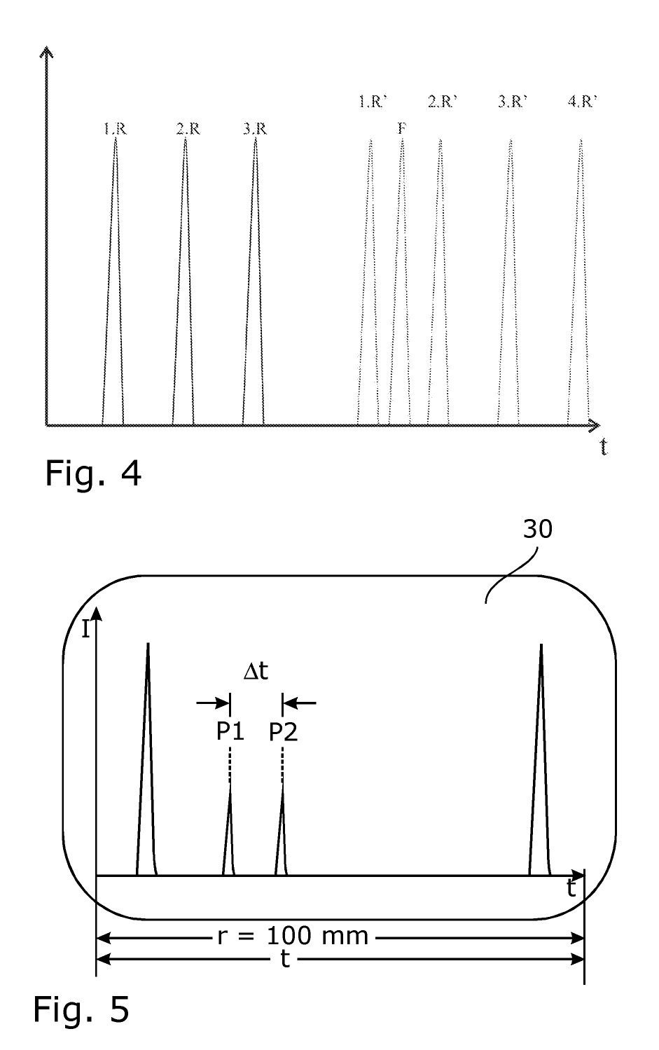

This can be clarified through the frequency hop Δf of the pulse repetition frequency f of the method according to the present invention; see FIGS. 3 and 4: Through reduction of the frequency f, the second pulse P′ is shifted in time with regard to the first pulse P, likewise the associated reflections and multiple reflections 1.R′ to 4.R′ are shifted, which, however, retain their mutual distance due to the unchanged workpiece geometry. Since now in the case shown in FIG. 3 the peak 4.R retains its time lag to the reflections and multiple reflections of the first pulse P (1.R to 3.R), the peak 4.R can be clearly identified as further multiple reflection of the first pulse P. The phantom echo assessed putatively as a discontinuity thus emerges as a “simple” (fourth) multiple reflection (4.R).

If, on the contrary, with the hop of the pulse repetition frequency f, as shown in FIG. 3, a shift of the peak F occurs, which corresponds to the shift of the second pulse P′ effected by the frequency hop, this reflection must be attributed to the second pulse P′ and can be clearly identified as a discontinuity of the workpiece.

As mentioned, the variation amount Δf can be adjusted automatically, so that a shift of phantom echoes of 3 to 5% of the imaging area adjusted to a display of an evaluation unit is discernible compared to the useful echoes (i.e., the echoes connected with real structures of the unit under test). An example for such a display is depicted in FIG. 5. Here P1 depicts a phantom echo with a pulse repetition frequency (PRF) f1=1000 Hz as well as a second phantom echo with a PRF f2=f1−Δf. The time lag between the phantom echoes P1 and P2 is then determined as follows:

$$c = \frac{2 r}{t} ⇒ t = \frac{2 r}{c}$$

Furthermore, the value for Δt is given as:

$$Δ t = \frac{1}{f 2} - \frac{1}{f 1} = \frac{1}{f 1 - Δ f} - \frac{1}{f 1} = \frac{1}{f - Δ f} - \frac{1}{f}$$

This gives a value:

$$Δ f = \frac{1}{Δ t}$$

one obtains for Δf:

$$Δ f = \frac{1}{\frac{1}{f - Δ f} - \frac{1}{f}}$$

Under the condition:

Δt≡3% t

a value results for Δf:

$$Δ f = f - \frac{1}{\frac{6 \% r}{c} + \frac{1}{f}}$$

Based on this formula, an appropriate frequency hop Δf can be determined for concrete display-dimensions r (for example, r=100 mm) and—if desired—can be implemented in an automated manner. To be sure, another appropriate value can also apply to the time/spatial separation for Δt of the phantom echoes P1 and P2, which, however, should preferably lie in the range between 1 and 15% of the indicated time interval/the indicated display width r.

1.-16. (canceled)

17. Method for non-destructive ultrasonic testing, in which ultrasonic pulses with a pulse repetition frequency are radiated by means of an ultrasonic transmitter into a workpiece to be tested and the ultrasonic pulses are reflected to bounding surfaces in the workpiece and the reflected ultra sound is recorded by means of an ultrasonic receiver and the signals are displayed in time- or position-dependent resolution, wherein the pulse repetition frequency for identification of phantom echoes during displaying is changed repeatedly after a defined time lapse with a predefined hop Δf.

18. Method according to claim 17, wherein the pulse repetition frequency lies in the range of 500 Hz to 1.5 kHz.

19. Method according to claim 17, wherein the hop Δf with which the pulse repetition frequency is changed lies in the range of 0.25 to 10 Hz.

20. Method according to claim 19, wherein the defined time lapse is selected from the range of 100 to 500 ms.

21. Method according to claim 17, wherein the pulse repetition frequency is produced in a quartz stabilized manner.

22. Device for non-destructive ultrasonic testing comprising:
a. an ultrasonic transmitter, which is equipped to produce ultrasonic pulses and intromit sound into a workpiece,
b. an ultrasonic receiver, which is equipped to exclude echo signals of the ultrasonic pulses intromitted into the unit under test,
c. a control unit, which is equipped to excite the ultrasonic transmitter for transmission of a sequence of ultrasonic pulses with a defined pulse repetition frequency, whereby a stabilized clock-pulse generator is provided for the stabilization of the pulse repetition frequency, and
d. a frequency variation unit equipped to change the pulse repetition frequency repeatedly and after a defined time lapse by a preset amount Δf.

23. Device according to claim 22, wherein the frequency variation unit is equipped to change the pulse repetition frequency periodically by the amount Δf.

24. Device according to claim 23, wherein the periodic change of the pulse repetition frequency occurs with a frequency, which amounts to between 0.1 Hz and 1 KHz.

25. Device according to claim 22 wherein the detection unit is provided, which is equipped to detect such echo signals, whose time lag from the previous excitation pulse changes with a change of the pulse repetition frequency.

26. Device according to claim 25, wherein the detection unit is equipped to acquire the change of the time lag of the detected echo signals and to compare with the variation of the pulse repetition frequency.

27. Device according to claim 25, wherein the detection unit is equipped to mark for a further processing and/or to inhibit the detected echo signals, particularly those echo signals, whose time lag varies with the frequency.

28. Device according to claim 25, wherein the detection unit is equipped to vary the pulse repetition frequency, until no echo signals are detected any longer, whose time lag from the preceding excitation pulse apparently changes with a change of the pulse repetition frequency.

29. Device according to claim 28, wherein the pulse repetition frequency is varied continuously or in a large number of discrete stages.

30. Device according to claim 22, wherein a display unit is provided, on which the echo signals recorded by the ultrasonic receiver are displayed in time- or position-dependent resolution.
